(19) United States
(12) Patent Application Publication
(10) Pub. No.: US 2013/0287193 A1
(43) Pub. Date: Oct. 31, 2013

(54) UNIVERSAL PREPAID COMMUNICATIONS

(71) Applicant: IDT Corporation, Newark, NJ (US)

(72) Inventors: Edward J. KELLY, West Nyack, NY (US); Isai SHENKER, Westfield, NJ (US)

(21) Appl. No.: 13/931,124

(22) Filed: Jun. 28, 2013

Related U.S. Application Data
(63) Continuation of application No. 12/083,344, filed on Oct. 12, 2011.
(60) Provisional application No. 60/726,241, filed on Oct. 14, 2005.

(51) Int. Cl. H04M 17/00

(52) U.S. Cl. CPC H04M 17/10
USPC 379/114.2

(57) ABSTRACT

A communications system includes both cellular and land based telecommunications such as PSTN telephone, as well as cellular telephone. A subscriber may use prepaid cellular phone to make and receive calls via cellular network. A Mobile Switching Center (MSC) routes the subscriber's calls to and/or from wireline network for domestic connections and/or network for international connection. A Mobile Virtual Network Operator (MVNO) operates a prepaid vendor service control point (SCP), Prepaid Vendor Service Platform (PSP), and connected databases. A method of providing a universal communications account includes: providing at least one account to a customer, enabling use of the account for a first type of connection and a second type of connection; and debiting the account based at least in part on one of the first type of connection and the second type of connection.

### REFERENCE TO RELATED APPLICATION

This is a Continuation application of U.S. patent application Ser. No. 12/083,344, filed on Oct. 12, 2011, which is a National Phase Application of International Application No. PCT/US06/39189, filed on Oct. 6, 2006, and claims priority to Provisional Patent Application Ser. No. 60/726,241, filed Oct. 14, 2005 in the United States Patent Office, the entire contents of which are herein incorporated by reference.

### BACKGROUND

1. Field of the Disclosure

The present disclosure is directed to prepaid telecommunications accounts. More specifically, the present disclosure is directed to prepaid telecommunications accounts (such as prepaid calling cards or prepaid mobile phones, as non-limiting examples) that enable a user to use a communications network (e.g., a telephone network—which may be cellular/wireless or land based) to contact called parties.

2. Discussion of the Background Art

In the past, telecommunications providers provided prepaid accounts, such as debit calling cards, to enable users to complete telephone calls. However, prepaid land line accounts could not be combined with prepaid cellular accounts. As a result, the user was required to have multiple accounts containing separate—and uncombinable—amounts of money, which is inconvenient to the user.

### SUMMARY

In light of these difficulties, the inventors of the present disclosure developed a universal prepaid cellular and land line telephone account. Through the present disclosure, it is possible for a user to manage a universal account, which provides significant improvements over previous types of telephone accounts.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 provides a non-limiting example of the system of the present disclosure;

FIG. 2 provides a non-limiting example of a method according to the present disclosure;

FIG. 3 illustrates a non-limiting example of call flow according to the present disclosure;

FIG. 4 illustrates a non-limiting example of the callme feature of the present disclosure;

FIG. 5 illustrates a non-limiting example of a method of activating a universal account according to the present disclosure;

FIG. 6 provides a non-limiting detailed example of the call flow for the callme feature of the present disclosure; and

FIG. 7 provides a non-limiting example of a call flow for a universal balance account.

### DESCRIPTION OF THE PREFERRED EMBODIMENTS

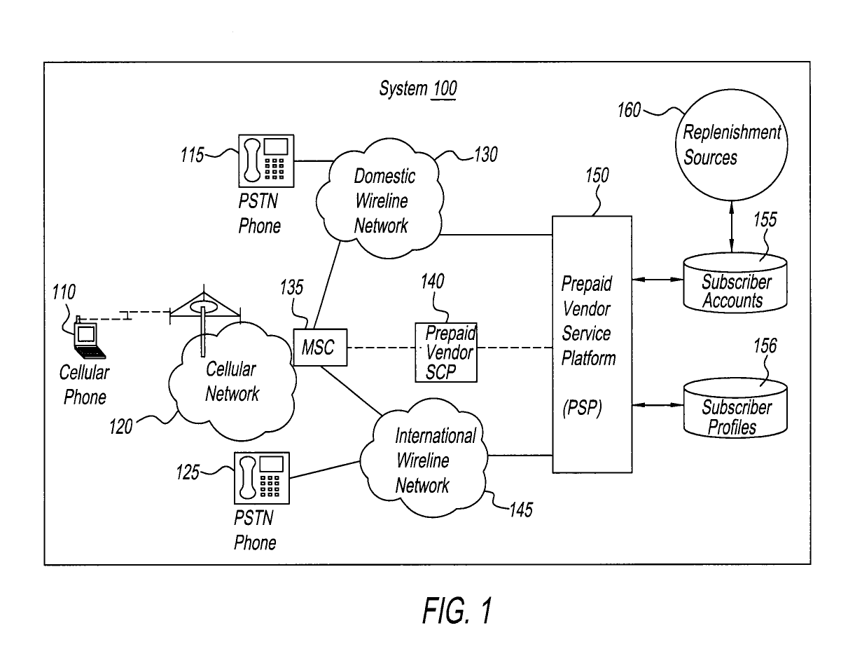

Referring now to the drawings, wherein like reference numerals designate identical or corresponding parts throughout the several views, a universal prepaid account according to a non-limiting aspect of the present disclosure is now described. As illustrated in FIG. 1, the present disclosure includes communications system 100. This communications system 100 includes both cellular and land based telecommunications. For example, the system includes PSTN telephones 115, 125, as well as cellular telephone 110.

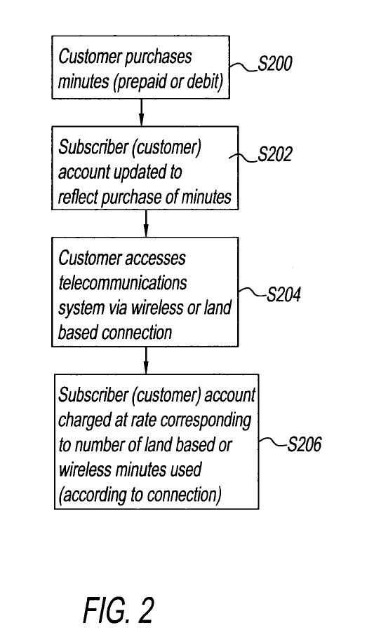

Use of the system of the present disclosure will be explained with reference to the following non-limiting example. As shown in FIG. 2, a customer purchases a quantity of telecommunications time in step S200. This telecommunications time may be correlated to a cash value. For example, a customer may purchase $25 worth of telecommunications time, irrespective of the connection rate being charged. (Generally, wireless connections are more expensive than land based connections.) In step S202, the customer (subscriber) account is updated to reflect the purchase of minutes. According to an aspect of the present disclosure, it is possible to provide a predetermined amount of minutes to the subscriber before the subscriber replenishes the account for the first time.

By way of explanation, the term “minutes” as used herein includes non-linear pricing plans. For example, wireless and/or land line pricing plans may include a fixed fee component such as a monthly subscription fee and/or a fixed charge covering use of up to a certain number of minutes per month, in addition to a per minute component for minutes exceeding the fixed fee component.

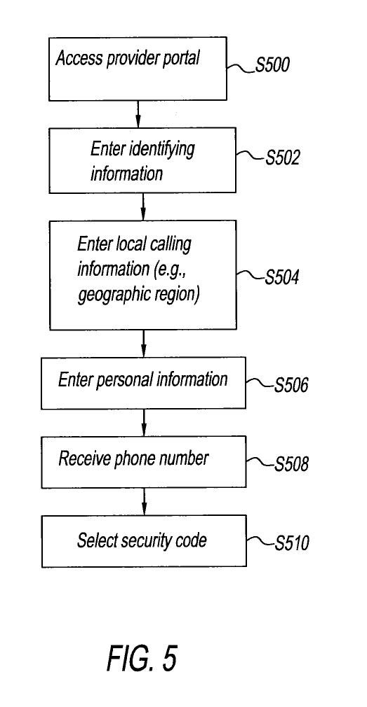

The subscriber account may be activated via the internet, when a customer calls the provider, and/or via a customer service location. A detailed example of a method of activating the system of the present disclosure is illustrated in FIG. 5. To this end, as shown in FIG. 5, a subscriber may access a provider portal, such as a website or prepaid phone service, in step S500. In step S502, the subscriber may enter identifying information, such as a phone serial number and/or SIM card number. In step S504, a subscriber may then enter a local calling area (e.g., geographic region or zip code). In step S506, the subscriber may enter personal information, such as name and address. In step S508, the subscriber may receive a telephone number from the system of the present disclosure. Finally, in step S510, the subscriber may select or receive a PIN/security/access code, Of course, these activation methods are merely exemplary, and other methods of activation known to those of skill in the art are included in the scope of this disclosure.

To replenish the subscriber's account according to the non-limiting embodiment illustrated in FIG. 2, the subscriber may access the database via one of several methods. For example, the customer may access the database from a land line via a toll free number. Alternatively, a customer may access the database using his cellular phone and an airtime free number. Once connected, the customer is identified (e.g., by his phone number) and then enters the PIN (e.g., an access/security code—verbally, by typing, or by other means known to those of skill in the art) that has been provided to the customer. This PIN number may represent the cash value of the card, and may be printed on the back of a calling card. Once the PIN number is entered, the cash value from the prepaid card is transferred to the customer's universal account balance in the database. This disclosure includes other methods of replenishment, including cross-plan use incentives. In other words, the disclosure includes the ability to replenish landline minutes as an incentive for the use of wireless minutes.

The customer's account may also be replenished using credit cards, ATM, and/or cash cards, and the transaction may be performed via telephone, internet, email, texting, or the like. Replenishment may occur directly at a point of service transaction device in a retail establishment, which may be connected over the internet, or by telephone, as non-limiting examples. For example, a clerk may associate a payment with a prepaid account number. While these methods of replenishment provide detailed examples, the replenishment aspects of the present disclosure should not be limited thereto.

Subsequently, when the customer desires to make a call, the customer accesses the telecommunications system via a wireless or land based network in step S204. As a result of the customer accessing the prepaid service platform to place the call, the subscriber (customer) account is charged at a rate corresponding to the number of land based or wireless minutes used in step S206.

In more detail, a subscriber may use prepaid cellular phone 110 to make and receive calls via cellular network 120. A Mobile Switching Center (MSC) 135 routes the subscriber's calls to and/or from wireline (e.g., land based PSTN and/or IP networks) network 130 for domestic connections and/or network 145 for international connections. In the case that the wireline network includes an IP network, additional platforms such as SIP servers and media gateways may be required. For the purposes of simplicity, these IP network features are not described in detail herein.

According to this non-limiting example, the MSC is preferably operated by a cellular infrastructure wireless service provider. However, other providers, as known to those of skill in the art, may also operate an MSC. For example, in the following explanation, a Mobile Virtual Network Operator (MVNO) may operate the MSC.

This disclosure also includes current and future generations of wireless (e.g., WiFi—IEEE 802.11, WiMAX—IEEE 802.16 and 802.20) and landline (e.g., VoIP) communication services. As a result, the disclosure includes follow on components (e.g., a functional replacement of today's MSC) as well as cellular phone follow-on devices. These devices imply pricing plans that are medium dependent (e.g., voice and text), which are incorporated in this disclosure.

The MVNO of the present disclosure also operates a prepaid vendor service control point (SCP) 140, Prepaid Vendor Services Platform (PSP) 150, and connected databases 155, 160, and 165. The PSP may be connected to subscriber accounts database 155 and subscriber profiles database 165. Subscriber accounts database 155 and subscriber profiles database 165 may be contained in a single database, at the discretion of the provider. Additionally, information within each of these two databases may overlap as desired by the provider. Subscriber profiles database 165 may include preferences.

These preferences may be set by the provider. For example, customers may be charged different rates to complete a call to the same location. These different rates may be based on a plan selected by the customer or a promotion offered by the provider, for example. The preferences may be entered into the database at the point of establishment of the account or at another time desired by the provider. For example, when the account is initially activated, a customer care system or provisioning system may establish the account with appropriate preferences.

Subscriber account replenishment means 160 updates subscriber accounts database 155, which reflects subscriber prepaid account replenishment through account replenishment methods such as retail point of sale, prepaid cards, and credit cards, as non-limiting examples.

As a non-limiting aspect of the present disclosure, a subscriber may use a universal subscriber account to obtain both prepaid cellular (wireless) services and prepaid wireline services. The rates charged for wireline services and prepaid cellular services are preferably different. These rates may be based on contractual arrangements between the PSP vendor and each subscriber, as reflected in subscriber account database 155. Additionally, the international wireline network 145 may also be operated by the PSP vendor or its agents.

Cellular access to voice, text, image, and video communication services is preferably provided by the cellular infrastructure wireless service provider, under a wholesale arrangement with the MVNO. For example, the customer care system may send a message to a wireless network that the customer is entitled to receive wireless services. Similarly, the customer care system may send a message to the calling card platform to provision calling card services.

The MVNO draws down the subscriber's prepaid account 155 based on, for example, contractual agreements between the subscriber and the PSP vendor. These charges may be based on a flat subscription, equipment rental and/or use, cellular and wireline access, and call completion, as well as other factors known to those of skill in the art. Call completion may be billed based on the type of connection (e.g., through domestic network 130 or international network 145).

Subscriber accounts 155 and subscriber profiles 165 may be populated upon subscriber provisioning (e.g., activation of the account). Provisioning may be concurrent for prepaid cellular and wireline services. As a non-limiting alternative, subscriber provisioning in prepaid cellular services may be subsequently updated with a subscription to prepaid wireline services, and vice versa. A subscriber may terminate either or both of the accounts at any time. Because the accounts are prepaid, risks to the telecommunications provider of non-payment and other credit related issues are avoided. Additionally, the present disclosure enables lower income and less credit worthy individuals to obtain improved telecommunications services.

As another non-limiting aspect of the present disclosure, a prepaid cellular subscriber may receive a compatible cellular phone for use with the MVNO's service. Outgoing and incoming cellular calls may be routed through the MSC 135. The incoming call routing may be accomplished through the use of pre-provisioned telephone numbers and cellular phone Equipment Identity Numbers. Call processing logic may be used to identify each cellular call as associated with the MVNO, thereby providing a trigger for SCP 140. The SCP may then use PSP 150, which may query subscriber accounts 155 and subscriber profiles 165 to ascertain that the subscriber's balance is sufficient to complete the desired telecommunication session of default minimum duration. The default minimum duration may be established at the discretion of the service provider. Platforms 135, 140, and 150 may be connected via signaling paths.

As a non-limiting aspect of the disclosure, media communications between MSC 135 and PSP 150 may be provided through a wired network such as domestic wireline network 130. Media communications include, but are not limited to text, image, and multimedia. This network may include private lines, which are dedicated lines (unswitched) directly connecting two or more communicating locations.

As illustrated in FIG. 1, the connection from MSC 135, SCP 140, and PSP 150 is dashed, which designates a signaling path. In this non-limiting example, the media flows from MSC 135 through network 130 (or optionally over a private line) to PSP 150.

Subscribers may also use wired telephones to access prepaid services using specific access numbers and PINs, for example, as well as other methods known to those of skill in the art. Subscribed services and levels of service may be differentiated through the use of different access numbers and PINS, for example, as well as by other methods known to those of skill in the art. Likewise, the calling ANI may be used to further authenticate the subscriber and to identify the level of service to be provided.

A subscriber dialing a PSTN phone 115 may use domestic wireline network 130 to reach the PSP 150 directly. The PSP permits outgoing calls to complete based on the balances available in subscriber accounts 155 and subscriber profiles 156. Calls may be completed through domestic wireline network 130 or through international wireline network 145. As another non-limiting example, PSP 150 may have access to multiple alternative call completion circuits (including VoIP), which enable the PSP 150 to balance quality of service requirements and costs.

The telecommunications system 100 illustrated in FIG. 1 may also include SS-7/AIN elements, such as service switching points. These elements may be located between PSP 150 and networks 130 and 145.

Features that may be provided to subscribers according to the present disclosure include (but are not limited to): nationwide long distance, national roaming, international long distance, universal calling card, SMS text messaging, voicemail, mid-call recharge, content download (e.g., ring tones, wallpapers, pictures, games, etc.), push to talk, paging, call forwarding, call waiting, caller ID, three-way calling, no answer/busy transfer, conferencing, internet access (e.g., email, instant messaging, etc.), and group accounts (e.g., family plans). Additionally, it is possible to display an amount of time remaining to the user on a handset display. Depending on the desired implementation, the time remaining may be always displayed on the handset or may be initiated by pressing a button on the handset that triggers the system of the disclosure to send the subscriber a text message containing the balance.

It is possible to charge subscribers fees in one of two ways, according to a non-limiting aspect of the disclosure. As an example of the first way, it is possible to charge in a tiered system. In the tiered system, the charge for text messaging might be 10 cents/day (up to ten messages/day), 25 cents/day (up to fifty messages/day), and 10 cents/message on overage. Of course, the provider may set prices as desired, and these values are merely exemplary.

As an example of the second way of charging subscribers, it is possible to set a price per use (e.g., 10 cents/send and 3 cents/receive). Of course, the provider may set prices as desired, and these values are merely exemplary.

While text messaging has been given as an exemplary service in the charge scenarios set forth above, all of the features provided to the subscriber may be charged in analogous manners. Additionally, the provider may charge subscribers with hybrid charging systems. In other words, some services may be priced in a tiered fashion while other services are priced per use.

The present disclosure may also provide a mid-call recharge feature. The mid-call recharge feature enables a subscriber to set the system to automatically recharge the subscriber's account when the account balance reaches a certain value. Alternatively, it is possible to interrupt the call so that the subscriber can recharge the account balance.

The universal calling card service enables a subscriber to the system of the present disclosure to use his minutes from any telephony device (wire-line phone, IP phone, etc.), as well as from the wireless handset. One non-limiting way in which this universal calling card service may be achieved is by having the subscriber dial an access number and entering a security/access code.

According to this aspect of the disclosure, it is also possible to charge the subscriber different rates, depending on how the call is initiated. For example, if the call is initiated from the subscriber's wireless handset, the rate might be 5 cents/minute. If the call is initiated from any other device, the rate may be 10 cents/minute. Of course, these rates and charging methods are merely exemplary, and other rates and charging methods may be set by the provider as desired.

Another non-limiting aspect of the present disclosure provides for group accounts, also referred to as family plans. Group accounts enable more than one subscriber to share minutes from a single account. Each member of the group account may have a different telephone number. One member may be defined as the “owner” of the group account. The owner of the group account may have additional access privileges to enable the owner to change the makeup of the group.

Members of the group may or may not share the same account balance. In other Words, each member of the group may have his own individual subscriber account apart from the group account. When members of the group are not sharing the same account balance, it is possible to modify and/or limit the rights of the owner of the group or to eliminate the use of an owner, as appropriate. In more detail, if subscribers who are group members are not sharing a single balance, it may not make sense to enable one group member to control the membership in the group. In such case, it is possible to have group accounts where there is no owner.

Additionally, it is possible to apply a different rate to calls made by individual members of the group. It is also possible to charge a group rate that may be applied to calls made between members of the group. For example, the group rate may be charged for calls made between provider mobile to provider mobile.

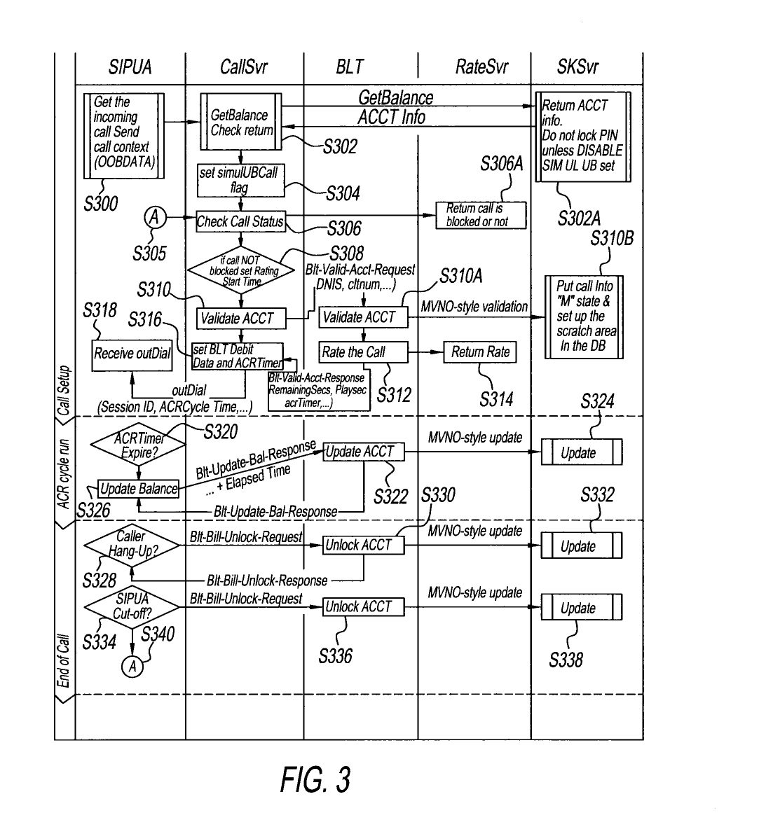

FIG. 3 illustrates a non-limiting example of the call flow for the provider according to a non-limiting aspect of the present disclosure. As shown in FIG. 3, a Session Interface Protocol User Agent (SIPUA), e.g., a switch, receives an incoming call in step S300. In this example, the incoming call may be from a toll free number, for example with a calling card. In that case, the caller would be prompted for an account number (e.g., a phone number) and a security code (not shown in FIG. 3). The caller may also be prompted for a destination phone number. However, in the callme scenario described below, the caller would not be prompted for a destination telephone number.

In step S300, the SIPUA receives data (e.g., OOBDATA) about the call. This data may include, but is not limited to: source of call, type of phone from which the call is being made (for example, a residential land line or a pay phone), etc.

In step S302, the call server (CallSvr), which has received information about the call from the SIPUA, queries the interface with the database (SKSvr) to determine the balance of funds available in the account. In step 302A, the SKSvr determines if the account number entered by the caller is a valid account and returns balance and account information to the CallSvr. The account information may include any information desired by the provider, such as available balance in the account, maximum number of minutes available for calling, the subscriber's name, or other information known to those of skill in the art.

In step S304, a flag is set to indicate that the account is in use. However, if the account entered by the caller is not a valid account number, the caller may be prompted to reenter the account number and security code.

In step S305, in the case where the destination phone number is not known, the caller may be prompted to enter a destination phone number. Step S305 may occur, for example, in situations where the caller is using a calling card to initiate the universal balance call. On the other hand, in the callme embodiment described below, it is most likely that the caller would not be prompted for a destination number because the destination number is already known to the system based on the account information.

After step S305, the system proceeds to check the call status in step S306. To do this, the CallSvr communicates with the RateSvr (e.g., a rate server) to determine if the call has been blocked in step S306A. Calls may be blocked for a number of reasons. For example, the provider may block calls to certain countries. As a non-limiting example, the provider may know that calls to countries such as Afghanistan are largely the result of fraudulent activity (e.g., stolen account information). Accordingly, the provider may elect not to complete the call and may inform the caller that the requested option is not available. In another non-limiting example, a subscriber may have requested that calls not be connected to his mobile phone. In such case, the caller may be informed that the requested option is not available and the call may not be connected. Of course, other reasons for blocking calls are within the scope of the present disclosure, as are other means of informing a caller that the call has been blocked.

If the call has not been blocked, the CallSvr sets the timer to monitor the running balance in the account being used for the call in step S308. In step S310, the CallSvr validates the account by communicating the DNIS and other information related to the call with the Business Logic Thread (BLT). In steps S310A, S312, and S314, the BLT communicates with the RateSvr to determine the rate (e.g., the charge per unit of time, such as 3 cents/minute) that should be applied to the call. In step S310B, the BLT communicates with the SKSvr to put the account into “M” state, which means that a call is in progress. The SKSvr may use a scratch area in the database to continuously calculate the available balance for the account. In other words, a running balance is kept in the scratch area for the account as one or more calls are occurring using the account.

After the call has been rated in the BLT in step S312, the BLT communicates with the call server in step S316 to inform the CallSvr of information related to the call and the account. For example, the BLT may provide the CallSvr with information related to the remaining seconds of call time in the account, as well as other information known to those of skill in the art. In step S314, the BLT returns the rate to the RateSvr.

While steps S310, S310A, S310B, S312, S314, and S316 have been described as occurring in a certain order, the present disclosure is not limited to such order. All of the steps in FIG. 3 may be interchanged as desired by the provider.

As the final step in the call setup portion of FIG. 3, the SIPUA receives the outdial request from the CallSvr in step S318, and the system proceeds to connect the call. At the discretion of the provider, the provider may elect not to proceed to step S318. For example, the provider may elect not to proceed to step S318 if the account balance is below a certain threshold amount.

After call setup has been completed, the system proceeds to step S320 in the ACR cycle run. In this step, the system checks to see if the amount of talk time available in the account has expired. To do this, the system updates the balance available in steps S322, S324, and S326. In step S322, the BLT receives a request from the SIPUA for an updated account balance. The BLT then queries the SKSvr for the running balance from the scratch area of the server.

The running balance is continuously decremented based on the rate applied to the call and the amount of talk time that has elapsed. Additionally, according to the present disclosure, it is possible for a single account balance to support multiple activities at the same time. For example, a single account balance may be used to send SMS messages at the same time that the account balance is being used for a call. In such case, the system is capable of tracking and applying the charges for each type of use and decrementing the account balance for each use in real time or in near real time. In other words, the running balance may be updated as wireline, and/or wireless calls, and/or wireless events progress.

In step S326, the SIPUA receives the updated account balance from the BLT. Steps S320, S322, S324, and S326 may be set to occur at desired intervals at the discretion of the provider. For example, these steps may be set to occur every four minutes. Of course, other desired intervals are within the scope of this disclosure.

The system then proceeds to steps S328 and steps S334, where the system monitors for a disconnection (hang up) by either the caller or the called party (step S328) or exhaustion of the balance in the account (step S334). At the discretion of the provider, “exhaustion” may occur at a value other than a zero account balance.

If a disconnection is detected in step S328, the account is unlocked by the BLT in step S330 after the BLT receives an unlock request from the SIPUA server. The BLT then communicates with the SKSvr in step S330 to update the scratch area to unlock the account in step S332 (provided that another call is not in session for the same account, in which case the scratch area would be updated to cease decrementing the account for the terminated call).

When the account balance is detected to be exhausted in step S334, either or both of the caller or the called party may be prompted to replenish the account in step S340, at the discretion of the provider. If the provider desires, the call may simply terminate in step S340 without prompting for replenishment. In such case, the system may provide a warning of termination to either party that the call is about to end.

After step S334, if the account is not replenished, the SIPUA requests the BLT to unlock the account in step S336. In step S338, the BLT requests that the account be updated in step S338 in a manner similar to or the same as that described with respect to step S332.

When the account information is updated in either or both of steps S332 and S338, the system may store information about the call into the account information. For example, the provider may associate information related to who called, how long the call lasted, the rate charged for the call, and the total charge to the account for the call. Other information known to those of skill in the art is, of course, within the scope of the disclosure.

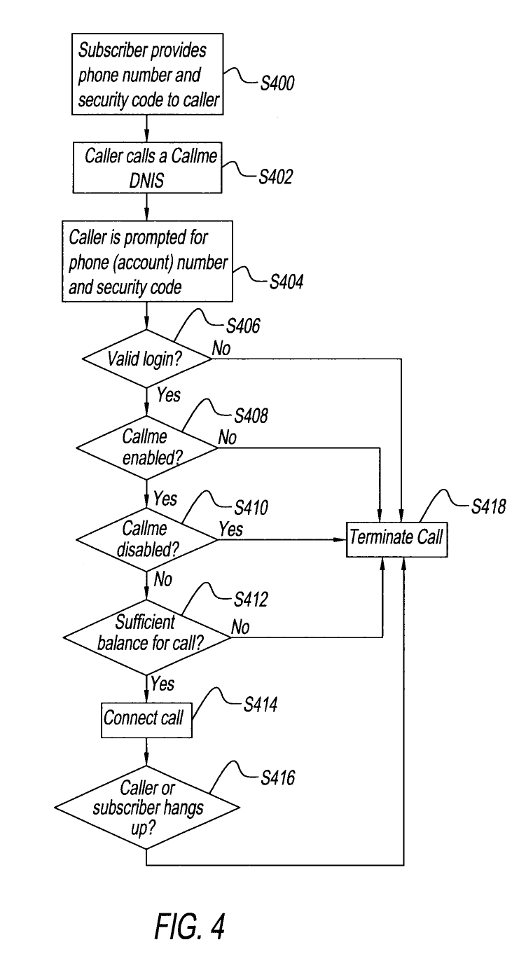

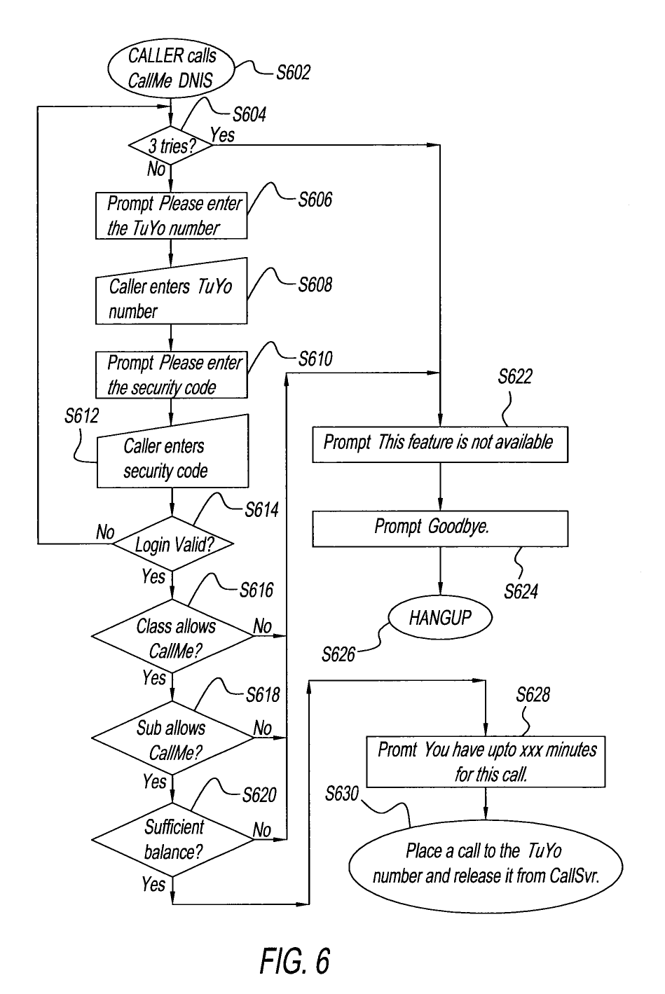

Another non-limiting aspect of the disclosure provides the “callme” feature. The callme feature enables a subscriber to give his phone number and security code (e.g., a four digit code) to another person, who can then use this information to call the subscriber. The callme access number may be a local number, a toll free number, or an international toll free service (ITFS) line. With ITFS access, subscribers may allow their friends and relatives to call them. from outside a particular geographic region (e.g., the United States) at the subscriber's expense. The caller may also be prompted with a language preference selection, as desired. To achieve the callme feature, the provider may provide country specific DNIS access. Aspects of the callme feature are illustrated in FIGS. 4 and 6.

As illustrated in FIG. 4, after the subscriber provides a phone number and security code to the caller in step S400, the caller calls a callme DNIS in step S402. In step S404, the caller may be prompted for a phone (or account) number and security code. If the security code and account information are deemed valid in step S406, the system verifies if the callme feature is enabled for the subscriber at step S408. Otherwise, the call is terminated at step S418.

Optionally, if the caller's login initially fails, the caller may be prompted to repeat the login attempts. If a predetermined number of attempted logins (e.g., three attempts) have occurred and the caller is still unsuccessful, the call may be terminated.

If callme is enabled, the system proceeds to step S410, in which the system checks if the subscriber has disabled the callme feature at the subscriber level. Otherwise, the call is terminated at step S418. If callme has not been disabled by the subscriber, the system proceeds to step S412 and checks if there is a sufficient balance in the subscriber's account to connect the call. If callme has been disabled by the user and the answer at step S410 is yes, the call is terminated at step S418. As a general rule, it is possible to provide a prompt at call termination, such as “this feature is not available, goodbye.”

When there is sufficient balance in the subscriber's account and callme has not been disabled, the call is connected in step S414. Once the system detects that either the caller or the subscriber hangs up the phone, the call is terminated in step S418. If the subscriber's account runs out of funds during the call, the subscriber may be prompted to provide a credit card or other funding source to augment the available account balance. Alternatively, it is possible to prompt the caller to provide additional funds to continue the call. When the account balance reaches a certain level (e.g., zero or other predetermined minimum balance), the call is automatically terminated. If the subscriber's account only has sufficient balance to connect the call (but not enough balance for the subscriber to receive the call (e.g., because of airtime charges), the call may be directed to voicemail. The call may also be directed to voicemail if the subscriber does not answer the call.

FIG. 6 provides a more detailed explanation of an exemplary callme call flow. As shown in FIG. 6, a caller calls a callme DNIS in step S602. In step S604, the system checks to see if the caller has attempted a predetermined number of logins. According to FIG. 6, the number of logins is three, but this number may be varied as desired by the provider. If the predetermined number of login attempts has not been reached, the system proceeds to step S606. Otherwise, the system proceeds to steps S622, S624, and S626 and terminates the call.

When the predetermined number of login attempts has not been exceeded, the caller is prompted to enter the callme or wireless account number (e.g., the subscriber's account or phone number) in step S606. In step S608, the caller enters the callme number. In the example of FIG. 6, the wireless account number is referred to as the “TuYo number.” After the caller enters the callme or wireless number, the user is prompted in step S610 to enter the security code for the account. If the login is determined to be valid in steps S612 and S614 (e.g., the account number and security code are valid), the system checks to see if the provider has granted the subscriber's account callme rights in step S616. If the login is not valid in steps S612 and S614, the system returns to step S604.

If the provider has not enabled the subscriber's account to have the callme feature, the system proceeds to step S622, where the system informs the caller that the callme feature is not available. In step S624, the system says goodbye to the caller and the call is terminated in step S626.

If the provider has enabled the subscriber's account to have the callme feature, the system checks to see if the subscriber has disabled the callme feature in step S618. If the subscriber has disabled the callme feature (e.g., the answer in step S618 is no), the system proceeds to step S622.

If the subscriber has not disabled the callme feature, the system proceeds to step S620 to check if there is sufficient balance in the subscriber's account. If the answer is no, the system proceeds to step S622. Otherwise, the system proceeds to step S628, where the system may inform either or both of the caller and the subscriber of the number of minutes available for the call. Step S628 is optional, at the discretion of the provider. In step S630—which may occur directly after step S620, the system places the call to the callme subscriber and the call is released from the CallSvr.

In this non-limiting embodiment, the subscriber is being called at a wireless phone. However, the subscriber may be contacted at a land line phone. In fact, other means of communication at which the subscriber could be contacted are also within the scope of this disclosure.

When a subscriber accesses voicemail, the subscriber may be charged for both the time that the caller used to record the message and the time used by the subscriber to retrieve the message. However, it is optional to charge the subscriber a fee for the voicemail service.

Additionally, a non-limiting aspect of the disclosure enables automatic recharging of the subscriber's account balance. For example, a subscriber may provide a credit or debit card when the account is opened (or at any time after the account has been opened). When the system detects that the subscriber's account has reached a predetermined balance (e.g., a minimum amount sufficient to complete a call) the system may automatically apply a charge to the credit or debit card to replenish the account. The amount of the charge may be set by either the subscriber or the services provider, as desired.

In an exemplary embodiment of the disclosure, at least one of the caller and the subscriber may be warned that the call is about to end. The warning may be in the form of a beep or other signal, for example.

Additionally, although not illustrated in FIGS. 4 and 6, the system may update the balance in the subscriber's account as the call continues to progress and once the call has been terminated in step S418 (not illustrated in FIG. 6). To calculate the charges to be applied to the account, it is possible to rely upon a fixed rate schedule that may be published to the subscribers.

Alternatively, it is possible to base the charges on a mobile terminating rate. For example, if the calling card rate is 5 cents/minute for ITFS calls from Mexico to the United States and the incoming wireless rate is 10 cents/minute and the subscriber's balance is $3.00, then the callme call from Mexico will last 20 minutes (3.00/(0.05+0.10)). Of course, other methods of calculating charges that are known to those of skill in the art are within the scope of the present disclosure.

According to another non-limiting aspect of the present disclosure, it is possible to have multiple callme calls to a single subscriber at any given time. For example, one callme caller may be on hold while a parallel callme call is in progress. In such case, it is possible for the subscriber's account balance to be decremented at a faster rate (e.g., be charged a rate that is the sum of the costs each call—of course, other methods of decrementing the account are within the scope of this disclosure). The subscriber's account may also be decremented at a faster rate if another wireless call, calling card call, SMS messaging, or other activity is in progress (as discussed in more detail above).

Another feature of the present disclosure enables the call forwarding feature. Charges may be applied to the subscriber for use of this feature as desired by the provider.

From the provider's perspective, callme calls may be flagged with particular features so that the provider may more easily troubleshoot these calls. For example, by providing a specific identifier, the provider may quickly identify issues with callme calls from a particular geographic region.

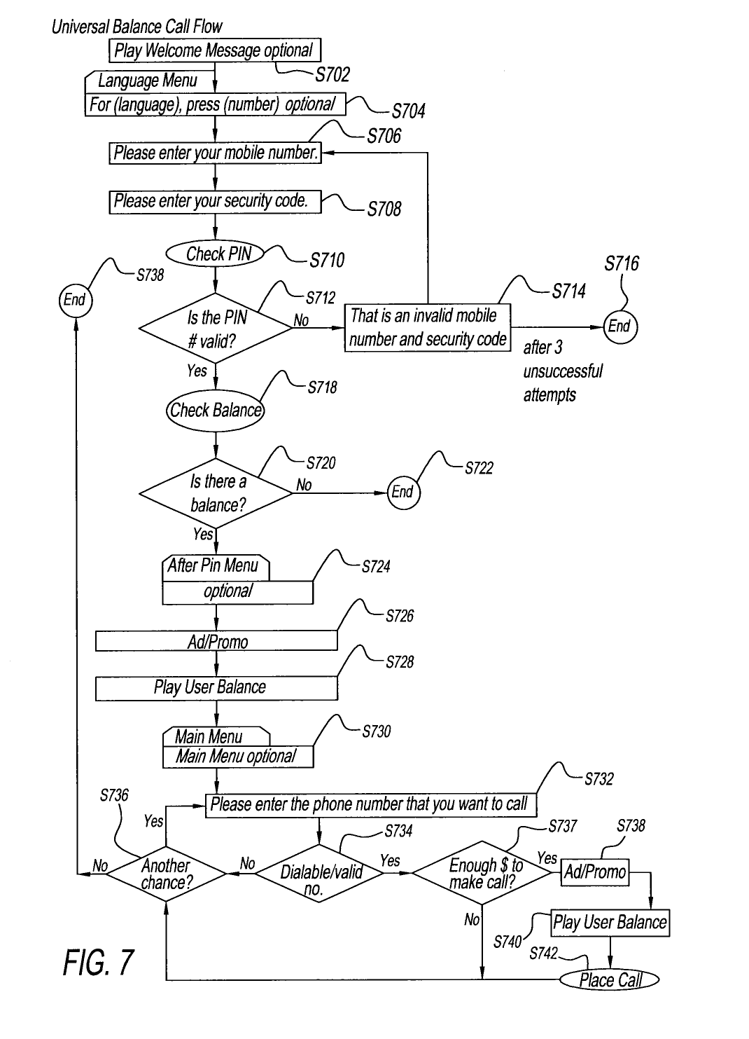

FIG. 7 illustrates an exemplary call flow for a universal balance account. As shown in FIG. 7, once a caller has accessed the system (e.g., by dialing a toll free access number), the system may play a welcome message to the caller in step S702. The caller may then be prompted to select a language in step S704. However, both steps S702 and S704 are optional at the discretion of the provider.

In step S706, the caller is prompted to enter an account number, such as a wireless account number. In step S708, the caller is prompted to enter a security code (e.g., a PIN number). After the security code is received by the system, the system checks to see if the security code is valid in steps S710 and S712. If the pin is invalid, the system proceeds to step S714, where the caller is informed that the information entered is invalid. If the caller has not exceeded a predetermined number of login attempts, the caller may be returned to step S706. Otherwise, the call is terminated in step S716.

When the account information entered by the caller is deemed valid in step S712, the system proceeds to check the account balance in step S718. If the balance is determined to be insufficient in step S720, the call is terminated in step S722. At the provider's discretion, the caller may be informed that the account has insufficient funds and may be prompted to replenish the account.

If there is sufficient balance in the account to connect the call, the caller may be presented with a menu of additional options in step S724. For example, it is possible for the provider to play messages and offer the ability for the subscriber or caller to access other services. The provider may enable the subscriber or caller to sign up for a credit card, subscribe to a magazine, or to access other promotional features, as desired by the provider. However, step S724 is not required.

In step S726, the caller may be presented with one or more promotional messages. However, step S726 is not required.

In step S728, the system may present the account information, such as the account balance, to the caller. Step S728 is also optional at the discretion of the provider.

In step S730, the caller may be presented with a main menu of options. For example, the caller or subscriber may be able to listen to weather, news, sports, etc. and/or may be able to access promotional materials like those discussed above with respect to step S724. Step S730 is also optional at the discretion of the provider.

In step S732 (which may occur after step S720), the system prompts the caller to enter the destination telephone number. In step S734, the system determines if the destination number is a valid number. If the number is valid, the system then checks the account balance to determine if enough funds are in the account to complete the call in step S736. When there is sufficient account balance, the caller may again be presented with advertising or promotional information step S738 (optional), may hear the account balance or maximum talk time in step S740 (optional), and the call is connected in step S742.

If the destination number is determined to be invalid in step S734, the caller may be given another chance to enter the number in step S736. If the provider has set a predetermined number of attempts not to be exceeded for the caller to attempt to enter a destination number, the call may be terminated in step S738. Although not illustrated in FIG. 7, it is possible to prompt either the caller or the called party to replenish the account (or to automatically replenish the account), if desired by the provider.

According to the present disclosure, it is possible to cause the funds in a subscriber's account to expire. This may be done at the discretion of the provider. For example, if a subscriber's account is inactive for a predetermined period of time (e.g., 60 days), the subscriber may “expire” the subscriber's account and the account balance may be reset to zero. Alternatively and/or additionally, the provider may remove the subscriber's account and account information from the system.

The present disclosure includes processing of transmitted and received signals, and programs by which the received signals are processed. Such programs are typically stored and executed by a processor in a wireless receiver implemented in VLSI. The processor typically includes a computer program product for holding instructions programmed and for containing data structures, tables, records, or other data. Examples are computer readable media such as compact discs, hard disks, floppy disks, tape, magneto-optical disks, PROMs (EPROM, EEPROM, flash EPROM), DRAM, SRAM, SDRAM, or any other magnetic medium, or any other medium from which a processor can read.

The computer program product of the disclosure may include one or a combination of computer readable media to store software employing computer code devices for controlling the processor. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

While the disclosure has been described with reference to exemplary embodiments thereof, it is to be understood that the disclosure is not limited to the exemplary embodiments in any way and that the disclosure is intended to cover all the various modifications and equivalent steps which one of ordinary skill in the art would appreciate upon reading this specification. Moreover, although certain features of the disclosure have been described with respect to individual embodiments, it may be understood that the features of the embodiments may be interchangeable.

Numerous modifications and variations of the present disclosure are possible in light of the above teachings. It is therefore to be understood that within the scope of the appended claims, the disclosure may be practiced otherwise than as specifically described herein.

What is claimed is:

1. A method performed by a processor in accordance with instructions contained in a storage device, comprising:
receiving, from a calling telephone, a security code for placing a call to a destination telephone;
determining whether a pre-paid account associated with said destination telephone has a balance sufficient for said call; and
connecting said calling telephone and said destination telephone to said call, if said balance is sufficient for said call.

2. The method of claim 1, further comprising:
sending to said calling telephone, a message that indicates an approximate length of time that is available for said call, based on said balance.

3. The method of claim 1, further comprising:
debiting said account for a cost of said call, thus reducing said balance, while said call is in progress.

4. The method of claim 3, further comprising:
issuing a prompt if said account runs out of funds during said call.

5. The method of claim 1,
wherein said calling telephone is a first calling telephone, and
wherein said method further comprises:
receiving said security code from a second calling telephone; and
connecting said second telephone to said call.

6. A system comprising:
a processor; and
a storage device that contains instructions that are readable by said processor, and that control said processor to:
receive, from a calling telephone, a security code for placing a call to a destination telephone;
determine whether a pre-paid account associated with said destination telephone has a balance that is sufficient for said call; and
connect said calling telephone and said destination telephone to said call, if said balance is sufficient for said call.

7. The system of claim 6, wherein said instructions also control said processor to:
send to said calling telephone, a message that indicates an approximate length of time that is available for said call, based on said balance.

8. The system of claim 6, wherein said instructions also control said processor to:
debit said account for a cost of said call, thus reducing said balance, while said call is in progress.

9. The system of claim 8, wherein said instructions also control said processor to:
issue a prompt if said account runs out of funds during said call.

10. The system of claim 6,
wherein said calling telephone is a first calling telephone, and
wherein said instructions also control said processor to:
receive said security code from a second calling telephone; and
connect said second telephone to said call.

11. A storage medium comprising instructions that are readable by a processor, and that control said processor to:
receive, from a calling telephone, a security code for placing a call to a destination telephone;
determine whether a pre-paid account associated with said destination telephone has a balance that is sufficient for said call; and
connect said calling telephone and said destination telephone to said call, if said balance is sufficient for said call.

12. The storage medium of claim 11, wherein said instructions also control said processor to:
send to said calling telephone, a message that indicates an approximate length of time that is available for said call, based on said balance.

13. The storage medium of claim 11, wherein said instructions also control said processor to:
debit said account for a cost of said call, thus reducing said balance, while said call is in progress.

14. The storage medium of claim 13, wherein said instructions also control said processor to:
issue a prompt if said account runs out of funds during said call.

15. The storage medium of claim 11,
wherein said calling telephone is a first calling telephone, and
wherein said instructions also control said processor to:
receive said security code from a second calling telephone; and
connect said second telephone to said call.
